(19) United States
(12) Patent Application Publication
(10) Pub. No.: US 2026/0338034 A1
(43) Pub. Date: Oct. 29, 2026

(54) PARAPET LADDER FOR AN AERIAL LIFT

(71) Applicant: Zachary Kimbrough, Dallas, GA (US)

(72) Inventor: Zachary Kimbrough, Dallas, GA (US)

(21) Appl. No.: 19/191,846

(22) Filed: Apr. 28, 2025

(51) Int. Cl. E06C 5/02

(52) U.S. Cl. CPC E06C 5/02

(57) ABSTRACT

A parapet ladder apparatus for accessing a rooftop behind a ladder via a working platform assembly of an aerial lift includes a base ladder section which may mount to the working platform assembly and a fly ladder section which is mountable to the base ladder and positionable in a variety of positions along a length of the base ladder section. The fly ladder section is securable via a lock assembly in any of the variety of positions. A guide bar is mounted to the base ladder section and is positioned or is positionable to be spaced forwardly from the base ladder section, thereby allowing the fly ladder section to slide among the variety of positions by sliding between the base ladder section and the guide bar.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### Statement REGARDING PRIOR DISCLOSURES BY THE INVENTOR OR JOINT INVENTOR

Not Applicable

### BACKGROUND OF THE INVENTION

### (1) Field of the Invention

The disclosure relates to ladder apparatuses and more particularly pertains to a new ladder apparatus for accessing a rooftop behind a ladder via a working platform assembly of an aerial lift.

### (2) Description of Related Art Including Information Disclosed Under 37 CFR 1.97 and 1.98

The prior art discloses various ladder apparatuses which include extension members which are positionable in various positions to adjust a length of the ladder apparatus. In some such apparatuses, the ladder apparatus may be mounted to a movable platform such that the platform may be reached from a floor surface when the platform is positioned at various heights above the floor surface by adjusting the length of the ladder apparatus. However, the prior art fails to disclose such an apparatus that is mounted to a platform of an aerial lift such that surfaces behind barriers, such as rooftops of buildings behind parapet walls, may be accessed by climbing down the ladder apparatus from the platform, and in which a repositionable ladder portion is removably and slidably mounted to a base ladder portion. The prior art further fails to describe such an apparatus in which a guide bar may be used to prevent the repositionable ladder portion from falling away from the base ladder portion by extending over the repositionable ladder portion and facilitating the sliding engagement between the base ladder portion and the repositionable ladder portion.

### BRIEF SUMMARY OF THE INVENTION

An embodiment of the disclosure meets the needs presented above by generally comprising a base ladder section which is configured to mount to a work platform assembly of an aerial lift. The base ladder section comprises a pair of base side rails and a plurality of base rungs. The base side rails extend between a bottom end and a top end of the base ladder section, and each base rung is coupled to and extends between the base side rails. The base rungs are spaced from each other between the bottom end and the top end of the base ladder section.

A fly ladder section is couplable to the base ladder section in an overlapping manner and is positionable interchangeably in a plurality of positions with respect to the base ladder section. The positions are spaced from each other along a direction which extends between the bottom end and the top end of the base ladder section. The fly ladder section comprises a pair of fly side rails and a plurality of fly rungs. The fly side rails extend between a lower end and an upper end of the fly ladder section, and each fly rung is coupled to and extends between the fly side rails. The fly rungs are spaced from each other between the lower end and the upper end of the fly ladder section.

A lock assembly is configured to selectively secure the fly ladder section to the base ladder section in each of the plurality of positions. A guide bar is coupled to the base ladder section adjacent to the top end and is positionable in a guide position in which the guide bar is spaced forwardly of the base ladder section such that the fly ladder section is slidable between the base ladder section and the guide bar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective back view of a parapet ladder apparatus according to an embodiment of the disclosure in which a ladder mounting bracket is positioned in an extended position.

FIG. 2 is a perspective back view of the embodiment of FIG. 1 in which the ladder mounting bracket is positioned in a folded position.

FIG. 3 is a perspective front view of the embodiment of FIG. 1.

FIG. 4 is a front view of the embodiment of FIG. 1.

FIG. 5 is a side exploded view of the embodiment of FIG. 1.

FIG. 6 is a back view of the embodiment of FIG. 1.

FIG. 7 is a cross-sectional view of the embodiment of FIG. 1 taken from Line 7-in FIG. 2.

FIG. 8 is a detail view of a bracket lock of the embodiment of FIG. 1.

FIG. 9 is an in-use view of the embodiment of FIG. 1.

FIG. 10 is a detail view of the embodiment of FIG. 1 taken from Window 10 in FIG. 3.

FIG. 11 is a detail view of a securement fastener of the embodiment of FIG. 1 shown in three steps taken to deploy the securement fastener.

### DETAILED DESCRIPTION OF THE INVENTION

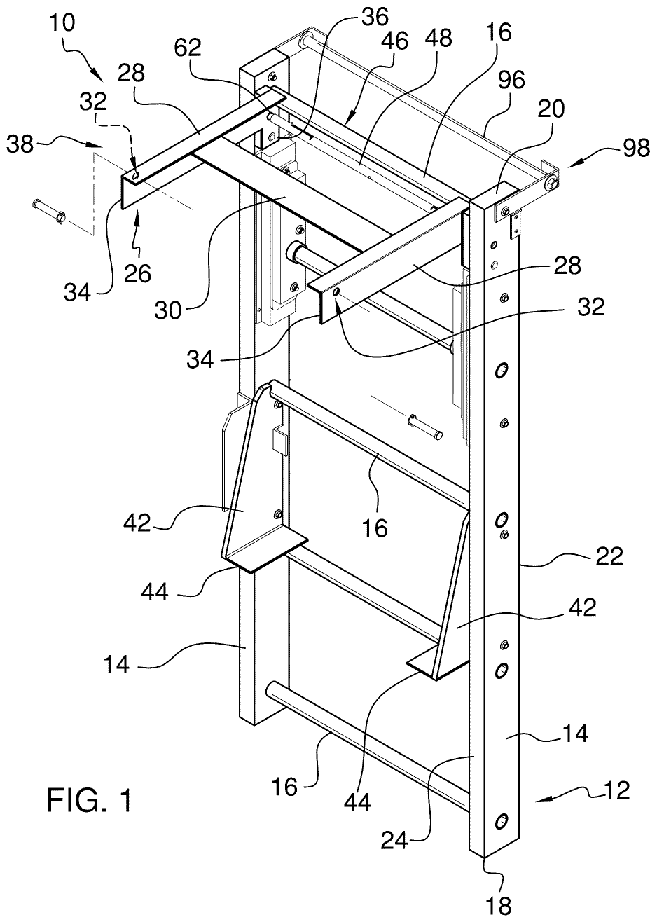

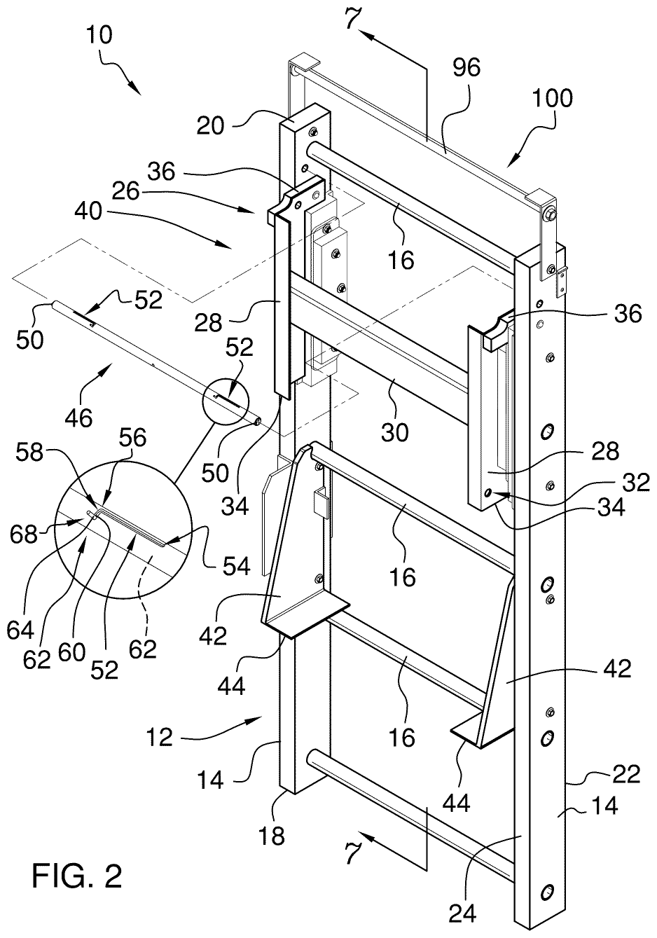

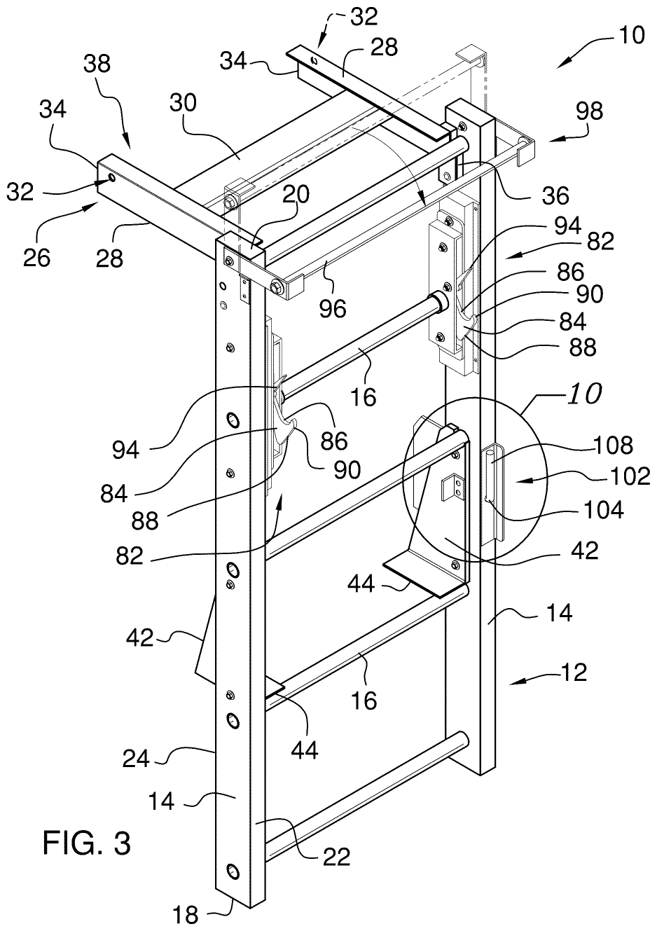

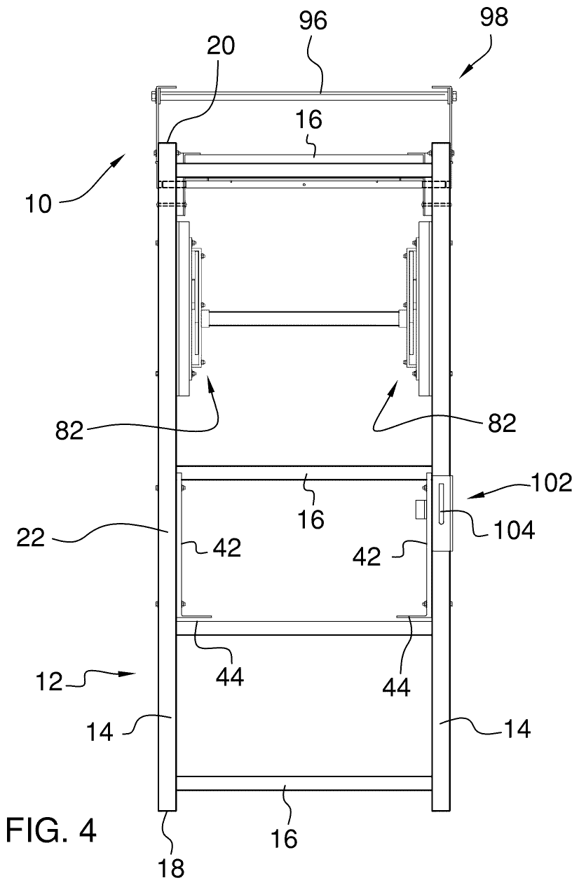

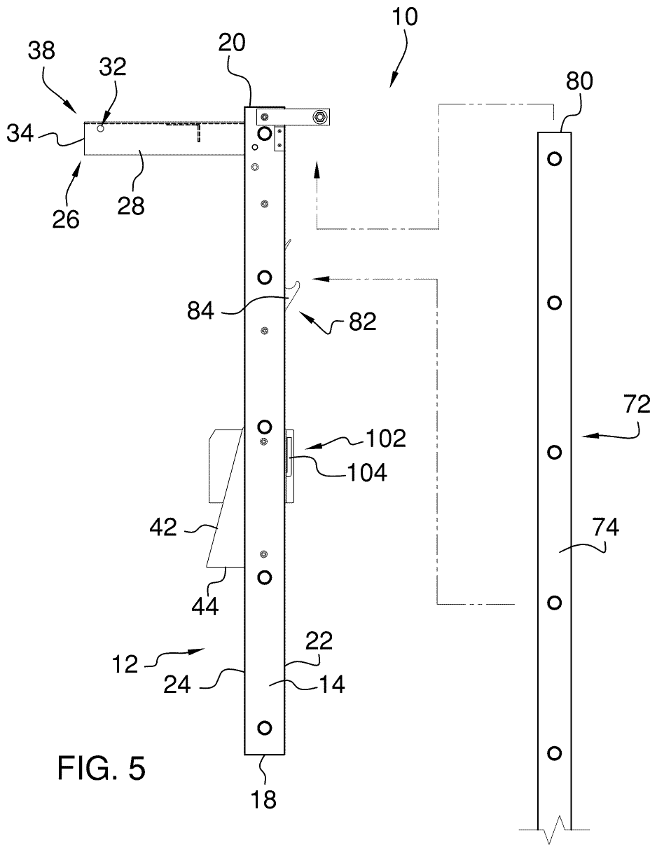

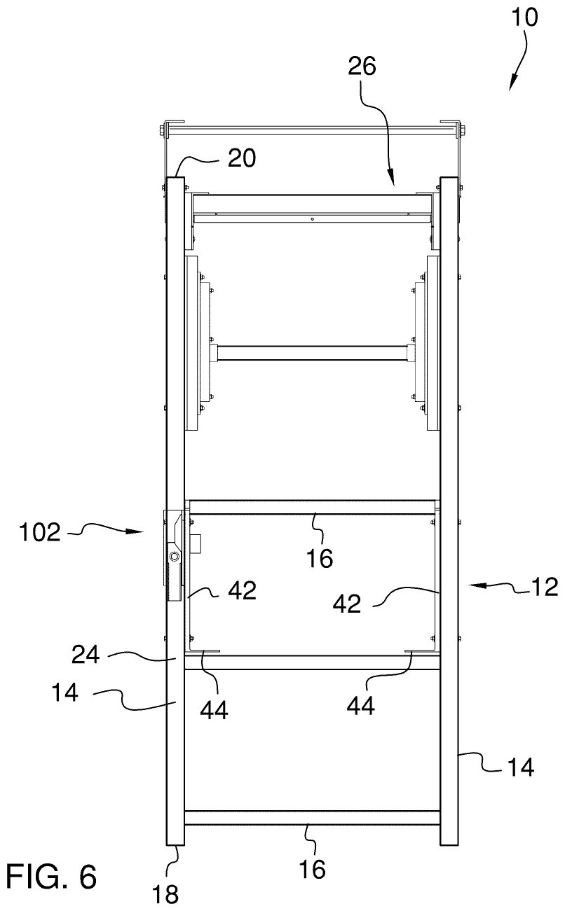

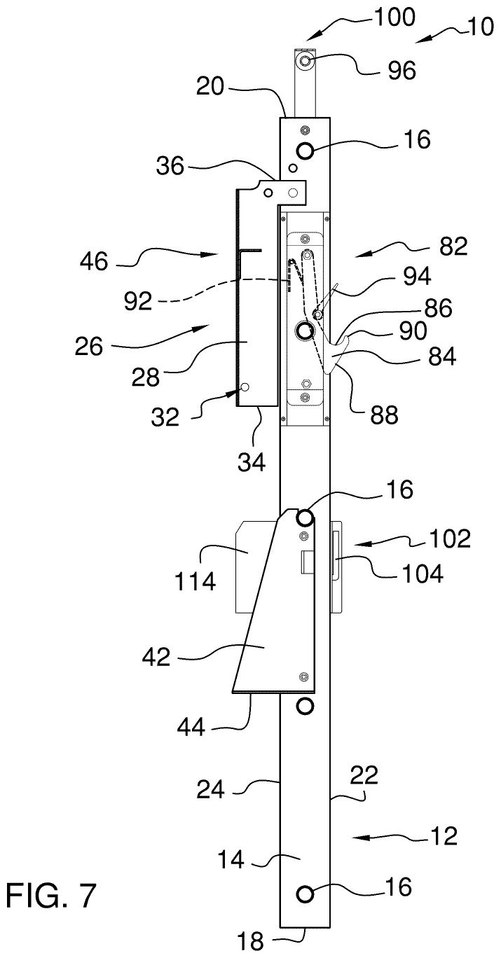

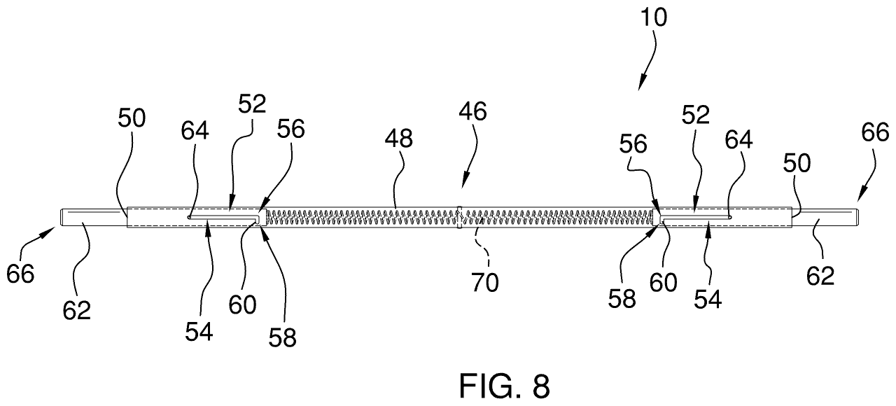

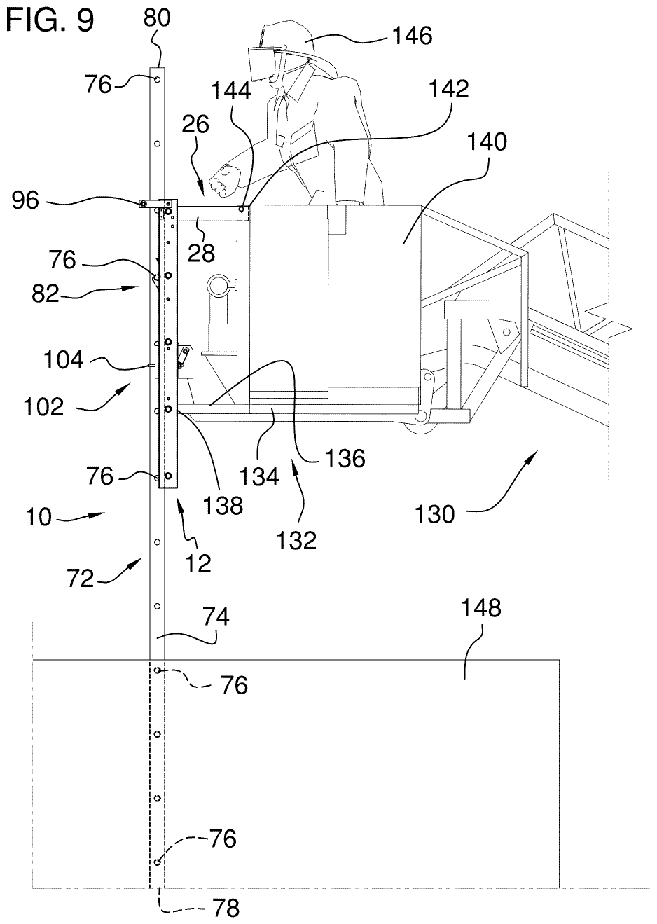

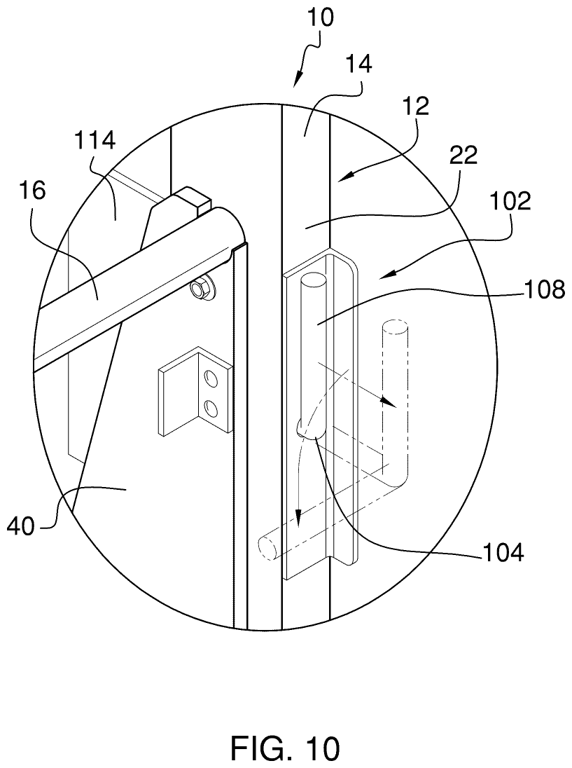

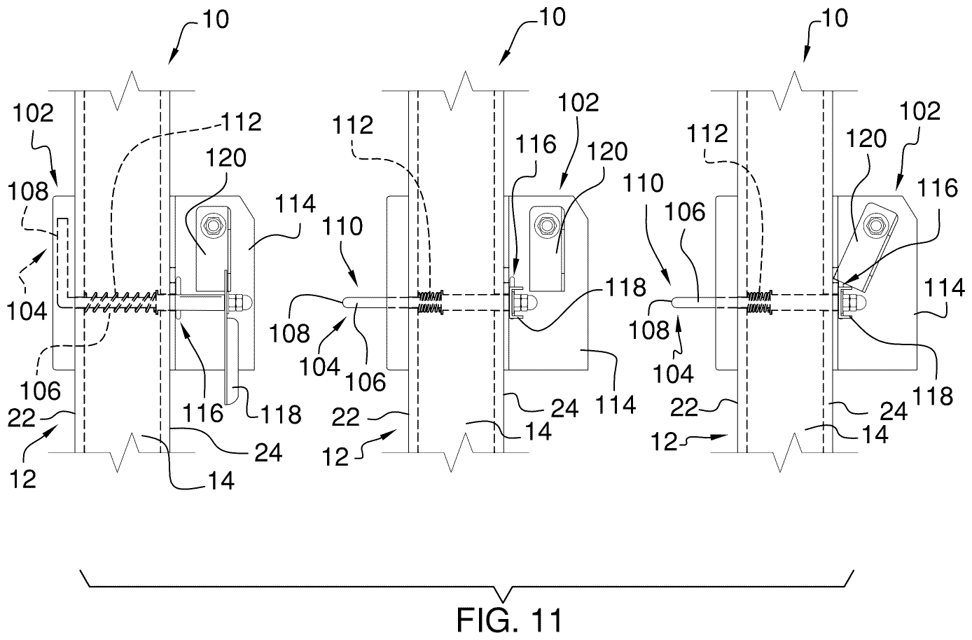

With reference now to the drawings, and in particular to FIGS. 1 through 11 thereof, a new ladder apparatus embodying the principles and concepts of an embodiment of the disclosure and generally designated by the reference numeral 10 will be described.

As best illustrated in FIGS. 1 through 11, the parapet ladder apparatus 10 generally comprises a base ladder section 12 which is configured to mount to a work platform assembly 132 of an aerial lift 130. The base ladder section 12 comprises a pair of base side rails 14 and a plurality of base rungs 16. The base side rails 14 extend between a bottom end 18 and a top end 20 of the base ladder section 12, and each base rung 16 is coupled to and extends between the pair of base side rails 14. The base rungs 16 are spaced from each other between the bottom end 18 and the top end 20 of the base ladder section 12.

The working platform assembly of the aerial lift 130 is depicted in the drawings as having a standing platform 134 and an upper mount member 142 which is spaced upwardly from the standing platform 134. The upper mount member 142 is mounted to a basket 140 for containing a user which is supported on and fixed to the standing platform 134. The base ladder section 12 attaches to the working platform assembly by a pin connection with the upper mount member 142 and resting atop an upper surface 136 of the standing platform 134.

A ladder mounting bracket 26 is coupled to the base ladder section 12 for mounting the base ladder section 12 to the upper mount member 142 of the work platform assembly 132. The ladder mounting bracket 26 comprises a pair of bracket arms 28 and a cross member 30 coupled to and extending between the pair of bracket arms 28. Each bracket arm 28 is mounted to an associated base side rail 14 of the pair of base side rails 14 and has an attachment hole 32 which extends therethrough for receiving a pin 144 to couple the ladder mounting bracket 26 to the upper mount member 142. The attachment hole 32 of each bracket arm 28 is positioned adjacent to a distal end 34 of the bracket arm 28 with respect to the base ladder section 12. Other connecting fasteners may extend through the attachment holes 32 of the bracket arms 28 such as threaded fasteners or the like.

The ladder mounting bracket 26 is pivotable between an extended position 38 and a folded position 40. When the ladder mounting bracket 26 is positioned in the extended position 38, the pair of bracket arms 28 extends rearwardly from the base ladder section 12 from a pivot end 36 of the bracket arm 28 to the distal end 34 of the bracket arm 28, thereby facilitating the pin connection to the upper mount member 142 of the working platform assembly which is set back from a front edge 138 of the standing platform 134. When the ladder mounting bracket 26 is positioned in the folded position 40, the pair of bracket arms 28 lie adjacent to the base ladder section 12 to form a size and form factor which makes storage of the parapet ladder apparatus 10 more convenient than keeping the ladder mounting bracket 26 in the extended position 38.

A pair of support members 42 is coupled to the base ladder section 12 and is positioned and configured to rest on the upper surface 136 of the standing platform 134 of the working platform assembly. Each support member 42 is mounted to an associated base side rail 14 of the base ladder section 12 and has a lower planar surface 44 which is positioned to rest atop the upper surface 136 of the standing platform 134.

The ladder mounting bracket 26 is securable in the extended position 38 via a bracket lock 46. The bracket lock 46 comprises a tube 48 and a pair of locking pins 62 slidably mounted in the tube 48. Each locking pin 62 is positionable in an engaged position 66 in which the locking pin 62 extends outwardly through an associated end 50 of a pair of ends 50 of the tube 48. The bracket lock 46 is positionable such that each locking pin 62 extends through in an associated bracket arm 28 of the pair of bracket arms 28 and into in an associated base side rail 14 of the base side rails 14 when the ladder mounting bracket 26 is positioned in the extended position 38 and the locking pin 62 is positioned in the engaged position 66. Suitable holes are formed in the bracket arms 28 and the base side rails 14 to facilitate this securing function.

The tube 48 has a pair of guide slots 52 which extend into the tube 48. Each guide slot 52 has a longitudinal portion 54 which extends between the pair of ends 50 of the tube 48 and a deviation portion 58 which extends circumferentially with respect to the tube 48 from an inner end 56 of the longitudinal portion 54 with respect to the tube 48. Each locking pin 62 comprises a protrusion 64 which extends through an associated guide slot 52 of the pair of guide slots 52 in the tube 48. The protrusion 64 of each locking pin 62 is positioned in the longitudinal portion 54 of the associated guide slot 52 when the locking pin 62 is positioned in the engaged position 66. Each locking pin 62 is also positionable in a secured disengaged position 68 in which the protrusion 64 of the locking pin 62 is positioned in the deviation portion 58 of the associated guide slot 52.

The bracket lock 46 further comprises a bracket lock bias member 70 which is coupled to and extends between the pair of locking pins 62. The bracket lock bias member 70 comprises a compression spring which biases the locking pins 62 outwardly from the tube 48. The protrusion 64 of each locking pin 62 is forcibly engaged with a seating face 60 of the deviation portion 58 of the associated slot via the bracket lock bias member 70 when the locking pin 62 is positioned in the secured disengaged position 68, thereby securing the locking pin 62 in the secured disengaged position 68.

The bracket lock 46 may also be applied to the ladder mounting bracket 26 to secure the ladder mounting bracket 26 in the folded position 40 in some embodiments. The locking pins 62 of the bracket lock 46 may be placed in the engaged positions 66 and inserted through suitable holes in the bracket arms 28 and the base side rails 14 similar to the use of the bracket lock 46 to secure the ladder mounting assembly in the extended position 38. In some embodiments, the tube 48 of the bracket lock 46 may be attached to the bracket arms 28.

Various other mounting assemblies may be used to secure the base ladder section 12 to the working platform assembly, and the working platform assembly may have a structure different from that shown in the Figures. The base ladder section 12 may be welded or otherwise permanently mounted to the working platform assembly in some embodiments.

A fly ladder section 72 is couplable to the base ladder section 12 in an overlapping manner and is positionable interchangeably in a plurality of positions with respect to the base ladder section 12. The positions are spaced from each other along a direction which extends between the bottom end 18 and the top end 20 of the base ladder section 12, thereby allowing users to climb further different distances downwardly (or upwardly in some use cases) from the working platform assembly. The fly ladder section 72 comprises a pair of fly side rails 74 and a plurality of fly rungs 76. The fly side rails 74 extend between a lower end 78 and an upper end 80 of the fly ladder section 72. Each fly rung 76 is coupled to and extends between the pair of fly side rails 74. The fly rungs 76 are spaced from each other between the lower end 78 and the upper end 80 of the fly ladder section 72.

A pair of lock assemblies 82 for selectively securing the fly ladder section 72 to the base ladder section 12 in each of the plurality of positions is mounted to the base ladder section 12 and is engageable to the fly ladder section 72. Each lock assembly 82 is positioned on an interior surface of an associated base side rail 14 of the pair of base side rails 14 of the base ladder section 12. Each lock assembly 82 comprises a hook member 84, a lock bias member 92, and a finger 94. The hook member 84 is pivotably coupled to the base ladder section 12 at a pivot end 36 of the hook member 84 and has a concave support surface 86 positioned distally from the pivot end 36 of the hook member 84. The concave support surface 86 is oriented to support a selected fly rung 76 of the plurality of fly rungs 76 of the fly ladder section 72. The hook member 84 has a lower surface 88 opposite the concave support surface 86 which is angled such that the hook member 84 is urged to pivot rearwardly relative to the base ladder section 12 when the lower surface 88 is forcibly engaged in an upward direction with respect to the base ladder section 12 during normal use.

The lock bias member 92 is positioned and configured to urge the hook member 84 to pivot forwardly with respect to the base ladder section 12. The lock bias member 92 comprises a torsion spring with arms positioned to engage the base ladder section 12 and the hook member 84 respectively and enable the movement described. However, other springs or elastic members may be used, such as tension springs, compression springs, leaf springs, rubber bands or the like. The finger 94 is pivotably coupled to the base ladder section 12. The finger 94 is freely pivotable with respect to the base ladder section 12 and is weighted or otherwise biased to rest against a front end 90 of the hook member 84 during normal use.

The finger 94 urges the hook member 84 rearwardly relative to the base ladder section 12 when the finger 94 is urged against the front end 90 of the hook member 84, thereby allowing the fly ladder section 72 to move downwardly past the finger 94 and the hook member 84 without catching on the hook member 84. The finger 94 extends beyond the front end 90 of the hook member 84 such that the finger 94 may be urged away from the hook member 84 when one of the plurality of fly rungs 76 is urged against the lower surface 88 of the hook member 84 toward the finger 94. In this manner, moving one of the fly rungs 76 upwardly with respect to the base ladder section 12 moves the finger 94 away from the front end 90 of the hook member 84, and the one fly rung 76 may then be placed and secured upon the concave support surface 86 of the hook member 84.

The lock assemblies 82 may comprise other mechanisms known in the art in other embodiments.

A guide bar 96 is coupled to the base ladder section 12 and is positioned adjacent to the top end 20 of the base ladder section 12. The guide bar 96 is positionable in a guide position 98 in which the guide bar 96 is spaced forwardly of the base ladder section 12 at a distance such that the fly ladder section 72 is slidable between the base ladder section 12 and the guide bar 96. The guide bar 96 is pivotably mounted to the base ladder section 12 and is pivotable rearwardly from the guide position 98 over the top end 20 of the base ladder section 12 to a retracted position 100. The guide bar 96 is spaced upwardly from the base ladder section 12 when positioned in the retracted position 100.

A securement fastener 102 for selectively securing the fly ladder section 72 against the base ladder section 12 is coupled to the base ladder section 12. The securement fastener 102 comprises an engagement pin 104 which is coupled to one of the base side rails 14. The engagement pin 104 has a sliding portion 106 and a retaining portion 108 which are coupled together in an L-shape. The sliding portion 106 is slidably mounted to the one base side rail 14, and the retaining portion 108 extends perpendicularly with respect to the sliding portion 106. The engagement pin 104 is rotatable with respect to the one base side rail 14 about a longitudinal axis of the sliding portion 106. The engagement pin 104 is positionable in a deployed position 110 in which the retaining portion 108 is spaced away from the one base side rail 14 and extends over a front side 22 of the base ladder section 12. When the engagement pin 104 is in the deployed position 110, the fly ladder section 72 is slidably positionable between the retaining portion 108 of the engagement pin 104 and the base ladder section 12.

The securement fastener 102 further comprises a securement bias member 112 which is coupled to the engagement pin 104 and the base ladder section 12. The securement bias member 112 is biased to urge the retaining portion 108 of the engagement pin 104 toward the base ladder section 12. The securement fastener 102 also includes a securement mounting bracket 114, a first locking member 118, and a second locking member 120. The securement mounting bracket 114 is coupled to the one base side rail 14 on a back side 24 of the base ladder section 12. The first locking member 118 is coupled to the engagement pin 104 and is positioned to extend into a slot 116 of the securement mounting bracket 114 when the engagement pin 104 is in the deployed position 110. The first locking member 118 engages the securement mounting bracket 114 to prevent the engagement pin 104 from moving rearwardly with respect to the base ladder section 12 when the first locking member 118 is positioned in the slot 116. The second locking member 120 is pivotably coupled to the securement mounting bracket 114 and is positionable against the first locking member 118 when the first locking member 118 is positioned in the slot 116 of the securement mounting bracket 114 to prevent a movement of the first locking member 118 out of the slot 116.

In use, the parapet ladder apparatus 10 is mounted to the working platform assembly of the aerial lift 130, which may be a component of a fire truck or similar device. The ladder mounting bracket 26 and the pair of support members 42 secure the base ladder section 12 to the working platform assembly as further described above. The base ladder section 12 may be used on its own with the guide bar 96 in the retracted position 100 to facilitate a user 146 such as a firefighter to climb down from the working platform assembly behind a parapet 148 of a building onto a roof of the building when the parapet 148 is sufficiently short enough for the user 146 to do so with only the base ladder section 12 attached.

To increase a distance with which the user 146 may climb down from the working platform, the fly ladder section 72 is positioned in overlapping fashion over the base ladder section 12 and the guide rail is pivoted into the guide position 98. The fly ladder section 72 may then be adjusted to a desired position with respect to the base ladder section 12 by sliding the fly ladder section 72 between the base ladder section 12 and the guide rail. The fly ladder section 72 is secured in the desired position via the lock assemblies 82, and the securement fastener 102 may be engaged to further secure the fly ladder section 72 against the base ladder section 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A parapet ladder apparatus for an aerial lift, the parapet ladder apparatus comprising:
a base ladder section configured to mount to a work platform assembly of the aerial lift, the base ladder section comprising a pair of base side rails and a plurality of base rungs, the pair of base side rails extending between a bottom end and a top end of the base ladder section, each base rung of the plurality of base rungs being coupled to and extending between the pair of base side rails, the plurality of base rungs being spaced from each other between the bottom end and the top end of the base ladder section;
a fly ladder section which is couplable to the base ladder section in an overlapping manner and is positionable interchangeably in a plurality of positions with respect to the base ladder section, the plurality of positions being spaced from each other along a direction which extends between the bottom end and the top end of the base ladder section, the fly ladder section comprising a pair of fly side rails and a plurality of fly rungs, the pair of fly side rails extending between a lower end and an upper end of the fly ladder section, each fly rung of the plurality of fly rungs being coupled to and extending between the pair of fly side rails, the plurality of fly rungs being spaced from each other between the lower end and the upper end of the fly ladder section;
a lock assembly configured to selectively secure the fly ladder section to the base ladder section in each of the plurality of positions; and
a guide bar coupled to the base ladder section adjacent to the top end, the guide bar being positionable in a guide position in which the guide bar is spaced forwardly of the base ladder section such that the fly ladder section is slidable between the base ladder section and the guide bar.

2. The parapet ladder apparatus of claim 1, wherein the guide bar is movably mounted to the base ladder section, the guide bar being positionable in a retracted position in which the guide bar is not spaced forwardly of the base ladder section.

3. The parapet ladder apparatus of claim 2, wherein the guide bar is pivotably mounted to the base ladder section, the guide bar being pivotable rearwardly from the guide position over the top end of the base ladder section to the retracted position, the guide bar being spaced upwardly from the base ladder section when positioned in the retracted position.

4. The parapet ladder apparatus of claim 1, wherein the lock assembly is mounted to an interior surface of one of the base side rails of the base ladder section, the lock assembly being engageable to the fly ladder section, the lock assembly comprising:
a hook member pivotably coupled to the base ladder section at a pivot end of the hook member, the hook member having a concave support surface positioned distally from the pivot end of the hook member, the concave support surface being oriented to support a selected fly rung of the plurality of fly rungs of the fly ladder section, the hook member having a lower surface opposite the concave support surface, the lower surface being angled such that the hook member is urged to pivot rearwardly relative to the base ladder section when the lower surface is forcibly engaged in an upward direction with respect to the base ladder section;
a lock bias member positioned and configured to urge the hook member to pivot forwardly with respect to the base ladder section; and
a finger pivotably coupled to the base ladder section, the finger being freely pivotable with respect to the base ladder section, the finger being configured to rest against a front end of the hook member, wherein the finger urges the hook member rearwardly relative to the base ladder section when the finger is urged against the front end of the hook member, the finger extending beyond the front end of the hook member such that the finger may be urged away from the hook member when one of the plurality of fly rungs is urged against the lower surface of the hook member toward the finger.

5. The parapet ladder apparatus of claim 1, further comprising a securement fastener for selectively securing the fly ladder section against the base ladder section, the securement fastener comprising an engagement pin coupled to one of the base side rails, the engagement pin having a sliding portion and a retaining portion which are coupled together in an L-shape, the sliding portion being slidably mounted to the one base side rail, the retaining portion extending perpendicularly with respect to the sliding portion, the engagement pin being rotatable with respect to the one base side rail about a longitudinal axis of the sliding portion, the engagement pin being positionable in a deployed position in which the retaining portion is spaced away from the one base side rail and extends over a front side of the base ladder section, the fly ladder section being slidably positionable between the retaining portion of the engagement pin and the base ladder section when the engagement pin is in the deployed position.

6. The parapet ladder apparatus of claim 5, wherein the securement fastener further comprises a securement bias member coupled to the engagement pin and the base ladder section, the securement bias member being biased to urge the retaining portion of the engagement pin toward the base ladder section.

7. The parapet ladder apparatus of claim 6, wherein the securement fastener further comprises:
a securement mounting bracket coupled to the one base side rail on a back side of the base ladder section; and
a first locking member coupled to the engagement pin, the first locking member being positioned to extend into a slot of the securement mounting bracket when the engagement pin is in the deployed position, the first locking member engaging the securement mounting bracket to prevent the engagement pin from moving rearwardly with respect to the base ladder section when the first locking member is positioned in the slot.

8. The parapet ladder apparatus of claim 7, wherein the securement fastener further comprises a second locking member pivotably coupled to the securement mounting bracket and positionable against the first locking member when the first locking member is positioned in the slot of the securement mounting bracket to prevent a movement of the first locking member out of the slot.

9. The parapet ladder apparatus of claim 1, further comprising a ladder mounting bracket coupled to the base ladder section for mounting the base ladder section to the work platform assembly, the ladder mounting bracket comprising a pair of bracket arms and a cross member coupled to and extending between the pair of bracket arms, each bracket arm of the pair of bracket arms being mounted to an associated base side rail of the pair of base side rails, each bracket arm of the pair of bracket arms having an attachment hole extending therethrough for receiving a connecting fastener to couple the ladder mounting bracket to an upper mount member of the work platform assembly, the attachment hole of each bracket arm being positioned adjacent to a distal end of the bracket arm with respect to the base ladder section.

10. The parapet ladder apparatus of claim 9, wherein the ladder mounting bracket is pivotable between an extended position and a folded position, the pair of bracket arms extending rearwardly from the base ladder section from a pivot end of the bracket arm to the distal end of the bracket arm when the ladder mounting bracket is positioned in the extended position, the pair of bracket arms lying adjacent to the base ladder section when the ladder mounting bracket is positioned in the folded position.

11. The parapet ladder apparatus of claim 10, further comprising a bracket lock which is couplable to the ladder mounting bracket and the base ladder section to secure the ladder mounting bracket in the extended position, the bracket lock comprising:
a tube; and
a pair of locking pins slidably mounted in the tube, each locking pin of the pair of locking pins being positionable in an engaged position in which the locking pin extends outwardly through an associated end of the pair of ends of the tube, the bracket lock being positionable such that each locking pin extends through an associated bracket arm of the pair of bracket arms and into an associated base side rail of the base side rails when the ladder mounting bracket is positioned in the extended position and the locking pin is positioned in the engaged position.

12. The parapet ladder apparatus of claim 11, wherein:
the tube has a pair of guide slots which extend into the tube, each guide slot of the pair of guide slots having a longitudinal portion which extends between a pair of ends of the tube and a deviation portion which extends circumferentially with respect to the tube from an inner end of the longitudinal portion with respect to the tube; and
each locking pin of the pair of locking pins comprises a protrusion which extends through an associated guide slot of the pair of guide slots in the tube, the protrusion of each locking pin being positioned in the longitudinal portion of the associated guide slot when the locking pin is positioned in the engaged position, each locking pin of the pair of locking pins being positionable in a secured disengaged position in which the protrusion of the locking pin is positioned in the deviation portion of the associated guide slot.

13. The parapet ladder apparatus of claim 12, wherein the bracket lock further comprises a bracket lock bias member coupled to and extending between the pair of locking pins, the bracket lock bias member biasing the pair of locking pins outwardly from the tube, the protrusion of each locking pin being forcibly engaged with a seating face of the deviation portion of the associated slot via the bracket lock bias member when the locking pin is positioned in the secured disengaged position.

14. The parapet ladder apparatus of claim 1, further comprising a pair of support members coupled to the base ladder section and being positioned and configured to rest on an upper surface of a standing platform of the working platform assembly.

15. A parapet ladder apparatus for an aerial lift, the parapet ladder apparatus comprising:
a base ladder section configured to mount to a work platform assembly of the aerial lift, the base ladder section comprising a pair of base side rails and a plurality of base rungs, the pair of base side rails extending between a bottom end and a top end of the base ladder section, each base rung of the plurality of base rungs being coupled to and extending between the pair of base side rails, the plurality of base rungs being spaced from each other between the bottom end and the top end of the base ladder section;
a fly ladder section which is couplable to the base ladder section in an overlapping manner and is positionable interchangeably in a plurality of positions with respect to the base ladder section, the plurality of positions being spaced from each other along a direction which extends between the bottom end and the top end of the base ladder section, the fly ladder section comprising a pair of fly side rails and a plurality of fly rungs, the pair of fly side rails extending between a lower end and an upper end of the fly ladder section, each fly rung of the plurality of fly rungs being coupled to and extending between the pair of fly side rails, the plurality of fly rungs being spaced from each other between the lower end and the upper end of the fly ladder section;
a pair of lock assemblies for selectively securing the fly ladder section to the base ladder section in each of the plurality of positions, the pair of lock assemblies being mounted to the base ladder section and being engageable to the fly ladder section, each lock assembly of the pair of lock assemblies being positioned on an interior surface of an associated base side rail of the pair of base side rails of the base ladder section, each lock assembly of the pair of lock assemblies comprising:
a hook member pivotably coupled to the base ladder section at a pivot end of the hook member, the hook member having a concave support surface positioned distally from the pivot end of the hook member, the concave support surface being oriented to support a selected fly rung of the plurality of fly rungs of the fly ladder section, the hook member having a lower surface opposite the concave support surface, the lower surface being angled such that the hook member is urged to pivot rearwardly relative to the base ladder section when the lower surface is forcibly engaged in an upward direction with respect to the base ladder section;
a lock bias member positioned and configured to urge the hook member to pivot forwardly with respect to the base ladder section; and
a finger pivotably coupled to the base ladder section, the finger being freely pivotable with respect to the base ladder section, the finger being configured to rest against a front end of the hook member, wherein the finger urges the hook member rearwardly relative to the base ladder section when the finger is urged against the front end of the hook member, the finger extending beyond the front end of the hook member such that the finger may be urged away from the hook member when one of the plurality of fly rungs is urged against the lower surface of the hook member toward the finger;
a guide bar coupled to the base ladder section adjacent to the top end, the guide bar being positionable in a guide position in which the guide bar is spaced forwardly of the base ladder section such that the fly ladder section is slidable between the base ladder section and the guide bar, the guide bar being pivotably mounted to the base ladder section, the guide bar being pivotable rearwardly from the guide position over the top end of the base ladder section to a retracted position, the guide bar being spaced upwardly from the base ladder section when positioned in the retracted position;
a securement fastener for selectively securing the fly ladder section against the base ladder section, the securement fastener comprising:
an engagement pin coupled to one of the base side rails, the engagement pin having a sliding portion and a retaining portion which are coupled together in an L-shape, the sliding portion being slidably mounted to the one base side rail, the retaining portion extending perpendicularly with respect to the sliding portion, the engagement pin being rotatable with respect to the one base side rail about a longitudinal axis of the sliding portion, the engagement pin being positionable in a deployed position in which the retaining portion is spaced away from the one base side rail and extends over a front side of the base ladder section, the fly ladder section being slidably positionable between the retaining portion of the engagement pin and the base ladder section when the engagement pin is in the deployed position;
a securement bias member coupled to the engagement pin and the base ladder section, the securement bias member being biased to urge the retaining portion of the engagement pin toward the base ladder section;
a securement mounting bracket coupled to the one base side rail on a back side of the base ladder section;
a first locking member coupled to the engagement pin, the first locking member being positioned to extend into a slot of the securement mounting bracket when the engagement pin is in the deployed position, the first locking member engaging the securement mounting bracket to prevent the engagement pin from moving rearwardly with respect to the base ladder section when the first locking member is positioned in the slot; and
a second locking member pivotably coupled to the securement mounting bracket and positionable against the first locking member when the first locking member is positioned in the slot of the securement mounting bracket to prevent a movement of the first locking member out of the slot;
a ladder mounting bracket coupled to the base ladder section for mounting the base ladder section to the work platform assembly, the ladder mounting bracket comprising a pair of bracket arms and a cross member coupled to and extending between the pair of bracket arms, each bracket arm of the pair of bracket arms being mounted to an associated base side rail of the pair of base side rails, each bracket arm of the pair of bracket arms having an attachment hole extending therethrough for receiving a connecting fastener to couple the ladder mounting bracket to an upper mount member of the work platform assembly, the attachment hole of each bracket arm being positioned adjacent to a distal end of the bracket arm with respect to the base ladder section, the ladder mounting bracket being pivotable between an extended position and a folded position, the pair of bracket arms extending rearwardly from the base ladder section from a pivot end of the bracket arm to the distal end of the bracket arm when the ladder mounting bracket is positioned in the extended position, the pair of bracket arms lying adjacent to the base ladder section when the ladder mounting bracket is positioned in the folded position;
a bracket lock which is couplable to the ladder mounting bracket and the base ladder section to secure the ladder mounting bracket in the extended position, the bracket lock comprising:
a tube, the tube having a pair of guide slots which extend into the tube, each guide slot of the pair of guide slots having a longitudinal portion which extends between a pair of ends of the tube and a deviation portion which extends circumferentially with respect to the tube from an inner end of the longitudinal portion with respect to the tube;
a pair of locking pins slidably mounted in the tube, each locking pin of the pair of locking pins being positionable in an engaged position in which the locking pin extends outwardly through an associated end of the pair of ends of the tube, the bracket lock being positionable such that each locking pin extends through an associated bracket arm of the pair of bracket arms and into an associated base side rail of the base side rails when the ladder mounting bracket is positioned in the extended position and the locking pin is positioned in the engaged position, each locking pin of the pair of locking pins comprising a protrusion which extends through an associated guide slot of the pair of guide slots in the tube, the protrusion of each locking pin being positioned in the longitudinal portion of the associated guide slot when the locking pin is positioned in the engaged position, each locking pin of the pair of locking pins being positionable in a secured disengaged position in which the protrusion of the locking pin is positioned in the deviation portion of the associated guide slot; and
a bracket lock bias member coupled to and extending between the pair of locking pins, the bracket lock bias member biasing the pair of locking pins outwardly from the tube, the protrusion of each locking pin being forcibly engaged with a seating face of the deviation portion of the associated slot via the bracket lock bias member when the locking pin is positioned in the secured disengaged position; and
a pair of support members coupled to the base ladder section and being positioned and configured to rest on an upper surface of a standing platform of the working platform assembly.
